(19) United States
(12) Patent Application Publication
(10) Pub. No.: US 2022/0313556 A1
(43) Pub. Date: Oct. 6, 2022

(54) DRUG MIXING DEVICE, DRUG MIXING KIT COMPRISING THE SAME, AND METHOD OF MANUFACTURING THE SAME

(71) Applicant: Yong Hyun Kim, Gyeonggi-do (KR)

(72) Inventor: Yong Hyun Kim, Gyeonggi-do (KR)

(21) Appl. No.: 17/608,947

(22) PCT Filed: May 7, 2020
(86) PCT No.: PCT/KR2020/006006

§ 371 Date: Nov. 4, 2021

(30) Foreign Application Priority Data
May 8, 2019 (KR) 10-2019-0053658

(51) Int. Cl. A61J 1/20

(52) U.S. Cl. CPC A61J 1/2017; A61J 1/2037; A61J 1/2048; A61J 1/2096; B01F 2101/22

(57) ABSTRACT

A drug mixing device is configured to mix a first content in a liquid form in a first container and a second content in a liquid or powder form in a second container. According to an embodiment of the present disclosure, a first flow path extending from one end configured to allow a liquid inside the first container to flow into the first flow path through the one end to the other end configured to allow a liquid inside the second container to flow into the first flow path through the other end, a second flow path branching from a first branch point located on the first flow path and extending to an outlet port, and a third flow path extending to connect a second branch point located on the second flow path and a third branch point located on the first flow path are formed in the drug mixing device.

### TECHNICAL FIELD

The present disclosure relates to a drug mixing device, a drug mixing kit, and a method of manufacturing the same.

### BACKGROUND

In the medical field, a mixed drug in a liquid form may be injected into a patient by mixing a liquid or powder form, such as an analgesic, antibiotic, or anticancer drug, with another drug in a liquid form, a medicinal liquid, or a distilled water. An example of a method of mixing drugs in the related art is as follows. A container, such as a bag or vial containing a drug in a liquid form, a medicinal liquid, or a distilled water, is punctured by piercing the container with an injection needle of a syringe, the content inside the container is suctioned into and accommodated in the syringe, and the injection needle is withdrawn from the container. Then, another container containing a drug in a liquid or powder form is punctured by piercing the another container with the injection needle of the syringe, the drug in the liquid form, the medicinal liquid or the distilled water inside the syringe is injected into the another container, and then the another container is shaken to mix the contents therein. After the mixing is completed, the mixed solution in the another container is suctioned into the syringe through the injection needle to be accommodated in the syringe, and then the injection needle is withdrawn from the another container.

### SUMMARY

In the related art, in order to mix the contents in two containers with each other, there is a problem in that it is necessary to sequentially pierce the two containers with an injection needle of a syringe and to withdraw the injection needle of the syringe. Due to a complicated manual work in an urgent medical field, there is a problem in that the probability of contaminating the injection needle of the syringe by external contaminants or pathogens increases and the probability of an accident in which the injection needle touches the skin of medical staff increases. This is a very serious problem as it may have a significant adverse effect on the health of a patient and medical staff. Embodiments of the present disclosure solve the problems of the related art described above.

In the case of using an expensive sterilization facility in order to prevent the above-described problems in the related art, there is a problem that it not only incurs a high cost but is also difficult to use such a sterilization facility in an emergency situation in the medical field. Embodiments of the present disclosure solve the problems described above.

An aspect of the present disclosure provides embodiments of a drug mixing device for mixing a first content in a liquid form in a first container and a second content in a liquid or powder form in a second container. In the drug mixing device according to a representative embodiment, a first flow path extending from one end configured to allow a liquid inside the first container to flow into the first flow path through the one end to the other end configured to allow a liquid inside the second container to flow into the first flow path through the other end, a second flow path branching from a first branch point located on the first flow path and extending to an outlet port, and a third flow path extending to connect a second branch point located on the second flow path and a third branch point located on the first flow path are formed. The drug mixing device includes a body including a first connection portion configured to be coupled with the first container and a second connection portion configured to be coupled with the second container; a first sealer disposed in the second flow path and configured to be penetrated by a needle of a syringe; and a second sealer disposed in the second flow path at a position between the first branch point and a point where the first sealer is disposed, and configured to be penetrated by the needle of the syringe. The second branch point is located on the second flow path between the point where the first sealer is disposed and a point where the second sealer is disposed.

In the embodiments, the third branch point may be located on the first flow path between the first branch point and the one end of the first flow path.

In the embodiments, the second sealer, the second branch point, the first sealer, and the outlet port may be sequentially arranged on a straight line.

In the embodiments, the device may further include a backflow prevention part disposed in the third flow path and configured to prevent a liquid from flowing from the third branch point to the second branch point.

In the embodiments, the device may further include a valve disposed in the first flow path and configured to open and close a flow of a fluid.

In the embodiments, the valve may be disposed at a position between the first branch point and the third branch point.

In the embodiments, the first connection portion may include a plurality of hooks configured to be engaged with the first container, the second connection portion may include a plurality of hooks configured to be engaged with the second container, and the body may include a support portion supporting the first connection portion and the second connection portion.

In the embodiments, the device may further include a first needle forming a side of the one end of the first flow path and protruding to be insertable into an interior of the first container, and a second needle forming a side of the other end of the first flow path and protruding to be insertable into an interior of the second container. The plurality of hooks of the first connection portion may be arranged to be spaced apart from each other in a circumferential direction around the first needle, and the plurality of hooks of the second connection portion may be arranged to be spaced apart from each other in a circumferential direction around the second needle.

In the embodiments, the device may further include a first needle forming a side of the one end of the first flow path and protruding to be insertable into an interior of the first container, and a second needle forming a side of the other end of the first flow path and protruding to be insertable into an interior of the second container.

In the embodiments, the first needle and the second needle may be fixed to the body.

In the embodiments, at least one needle of the first needle and the second needle may define therein a remaining amount inflow hole in a side surface at a position spaced apart from a pointed end thereof. The drug mixing device may be configured to enable a liquid to flow into the first flow path from an interior of a container, into which the at least one needle is inserted, through the remaining amount inflow hole.

In the embodiments, the device may further include a supporter coupled to the body and configured to support the syringe.

Another aspect of the present disclosure provides embodiments of a method of manufacturing the drug mixing device. The method according to a representative embodiment includes fixing the first connection portion and the second connection portion to the support portion.

Still another aspect of the present disclosure provides embodiments of a drug mixing kit for mixing a first content in a liquid form in a first container and a second content in a liquid or powder form in a second container. The drug mixing kit according to a representative embodiment includes: a drug mixing device in which a first flow path extending from one end configured to allow a liquid inside the first container to flow into the first flow path through the one end to the other end configured to allow a liquid inside the second container to flow into the first flow path through the other end, a second flow path branching from a first branch point located on the first flow path and extending to an outlet port, and a third flow path extending to connect a second branch point located on the second flow path and a third branch point located on the first flow path are formed; and a syringe including a syringe housing having an internal space, a plunger configured to change a volume of the internal space by being inserted into the syringe housing and moving, and a syringe needle connecting the second flow path and the internal space to each other. The drug mixing device includes: a body including a first connection portion configured to be coupled with the first container and a second connection portion configured to be coupled with the second container; a first sealer disposed in the second flow path and configured to be penetrated by the syringe needle; and a second sealer disposed in the second flow path at a position between the first branch point and a point where the first sealer is disposed, and configured to be penetrated by the syringe needle. The second branch point is located on the second flow path between the point where the first sealer is disposed and a point where the second sealer is disposed.

In the embodiments, the drug mixing device and the syringe may be detachably coupled to each other.

According to the embodiments of the present disclosure, it is possible to significantly reduce the probability that a component inserted into a patient, such as an injection needle, or a drug administered to the patient is contaminated from external contamination sources or pathogens.

According to the embodiments of the present disclosure, it is possible for medical staff to safely mix drugs.

### BRIEF DESCRIPTION OF THE DRAWINGS

FIG. 1 is a perspective view illustrating the state in which a first container 6 and a second container 7 are coupled to a drug mixing kit 1 according to an embodiment of the present disclosure.

FIG. 2 is partial vertical cross-sectional view of the drug mixing kit 1, the first container 6, and the second container 7 taken along the line S1-S1′ in FIG. 1.

FIGS. 3A to 3G are vertical cross-sectional views illustrating a drug mixing device 100, a syringe 200, the first container 6, and/or the second container 7 taken along line S1-S1′ in FIG. 1 and sequentially showing an example of using the drug mixing kit 1 of FIG. 1.

### DETAILED DESCRIPTION

Embodiments of the present disclosure are illustrated for the purpose of explaining the technical idea of the present disclosure. The scope of the rights according to the present disclosure is not limited to the embodiments presented below or the detailed descriptions of such embodiments.

All technical and scientific terms used in the present disclosure have the meaning generally understood by those of ordinary skill in the art to which the present disclosure pertains, unless otherwise defined. All terms used in the present disclosure are chosen for the purpose of more clearly describing the present disclosure and are not chosen to limit the scope of rights according to the present disclosure.

As used in this disclosure, expressions such as “comprising,” “including,” “having,” and the like are to be understood as open-ended terms having the possibility of encompassing other embodiments, unless otherwise mentioned in the phrase or sentence containing such expressions.

The singular form used in the present disclosure may include a plural meaning unless otherwise mentioned. This applies to the singular form recited in the claims.

Terms such as “first” and “second” used in the present disclosure are used in order to distinguish a plurality of components from one another, and do not limit the order or importance of the corresponding components.

In the present disclosure, where it is mentioned in the present disclosure that one element is “connected” to another element, it is to be understood that the one element may be directly connected to the another element, or may be connected to the another element via a new additional element.

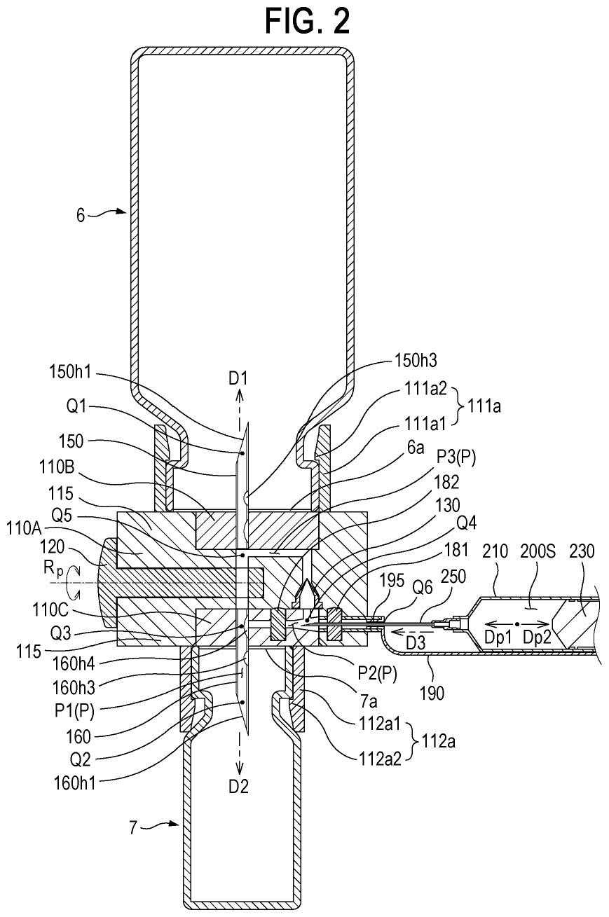

As used in the present disclosure, the term “first direction” means a direction in which a drug mixing device moves when the drug mixing device is brought close to a first container such that the drug mixing device and the first container are coupled to each other, and the term “second direction” means a direction in which the drug mixing device moves when the drug mixing device is brought close to a second container such that the drug mixing device and the second container are coupled to each other. As used in the present disclosure, the term “third direction” means a direction in which a syringe moves when the syringe is brought close to the drug mixing device such that the drug mixing device and the syringe are coupled to each other. FIG. 2 illustrates a first direction D1, a second direction D2, and a third direction D3, but each direction is not limited to the embodiments of the present disclosure.

Hereinafter, embodiments of the present disclosure will be described with reference to the accompanying drawings. In the accompanying drawings, identical or corresponding components are indicated by identical reference numerals. In the following description of embodiments, repeated descriptions of the identical or corresponding components will be omitted. However, even if a description of a component is omitted, such a component is not intended to be excluded in an embodiment.

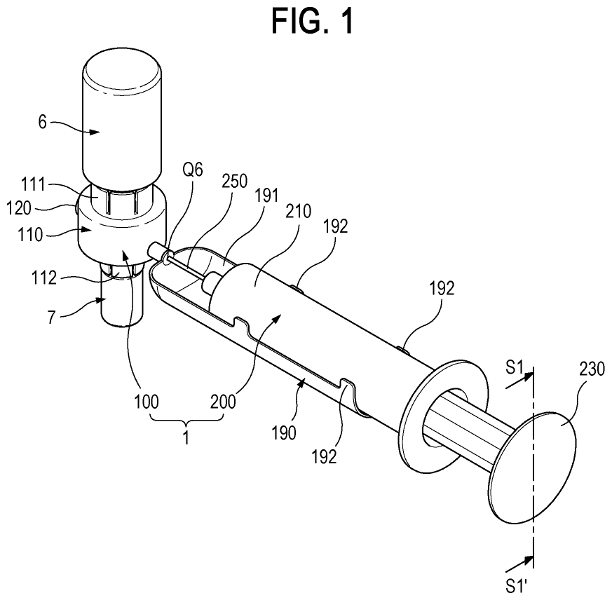

FIG. 1 is a perspective view illustrating a state in which a first container 6 and a second container 7 are coupled to a drug mixing kit 1 according to an embodiment of the present disclosure. Referring to FIG. 1, a user (e.g., medical staff such as a nurse or a doctor) may couple the first container 6 and the second container 7 to the drug mixing kit 1. The drug mixing kit 1 is configured to mix a first content in a liquid form in the first container 6 and a second content in a liquid or powder form in the second container 7.

The user may mix the first content with the second content using the drug mixing kit 1, and cause the mixture in which the first content and the second content are mixed to flow into a syringe 200. For example, the first content, such as a medicinal liquid, and the second content, which is a drug in a powder form, may be mixed. As another example, the first content, which is a drug in a liquid form, and the second content, which is another drug in a liquid form, may be mixed.

The drug mixing kit 1 includes a drug mixing device 100 and the syringe 200 coupled to the drug mixing device 100. The drug mixing device 100 and the syringe 200 may be detachably coupled to each other. The user may discharge a gas (e.g., sterile air) in the syringe 200 into the first container 6 using the drug mixing kit 1. The user may mix the first content with the second content using the drug mixing kit 1 and may separate the syringe 200 from the drug mixing device 100 after the mixture is filled in the syringe 200.

FIG. 2 is partial vertical cross-sectional view of the drug mixing kit 1, the first container 6, and the second container 7 taken along line S1-S1′ in FIG. 1. Referring to FIGS. 1 and 2, the drug mixing device 100 includes a flow path P configured to guide a flow of a liquid. The flow path P includes a first flow path P1, a second flow path P2, and a third flow path P3.

In the present embodiment, the first flow path P1 extends in a straight line, but according to an embodiment, the first flow path P1 may be bent or curved in some sections. In the present embodiment, the second flow path P2 extends in a straight line in a direction opposite to the third direction D3, but according to an embodiment, some sections of the second flow path P2 may be bent or curved. In the present embodiment, the third flow path P3 extends in the first direction D1 and is bent to extend in the third direction D3, but the shape of the third flow path P3 may vary depending on the embodiment. In addition, some components of the drug mixing device 100 may form at least a part of the first flow path P1, the second flow path P2, and/or the third flow path P3, and are not limited to the embodiments of the present disclosure.

In the drug mixing device 100, the first flow path P1 extends from one end Q1 configured to allow the liquid inside the first container 6 to flow into the first flow path P1 through the one end Q1 to the other end Q2 configured to allow the liquid inside the second container 7 to flow into the first flow path P1 through the other end Q2. The first flow path P1 is located in the drug mixing device 100. For example, the first content in a liquid form in the first container 6 may flow into the first flow path P1, and the mixture in a liquid form in the second container 7 may flow into the first flow path P1.

The one end Q1 of the first flow path P1 is disposed on the first container 6 side. The other end Q2 of the first flow path P1 is disposed on the second container 7 side. The one end Q1 is located at the distal end in the first direction D1 of the first flow path P1. The other end Q2 is located at the distal end in the second direction D2 of the first flow path P1.

The first flow path P1 includes a first section (not illustrated), a second section (not illustrated), and a third section (not illustrated). The first section and the second section are divided based on a third branch point Q5 between the first flow path P1 and the third flow path P3. The second section and the third section are divided based on a first branch point Q3 between the first flow path P1 and the second flow path P2. The first section extends to connect the one end Q1 and the third branch point Q5. The second section extends to connect the third branch point Q5 and the first branch point Q3. The third section extends to connect the other end Q2 and the first branch point Q3. The first section includes a portion extending in the first direction D1. The third section includes a portion extending in the second direction D2.

The second flow path P2 branching from the first flow path P1 is formed in the drug mixing device 100. The second flow path P2 branches from the first branch point Q3 located on the first flow path P1 and extends to an outlet port Q6. The second flow path P2 is located in the drug mixing device 100. In the embodiment of the drug mixing device 100 separated from the syringe 200, the second flow path P2 may be blocked by sealers 181 and 182. In the embodiment of the drug mixing kit 1 in which the syringe 200 and the drug mixing device 100 are combined, the second flow path P2 may be opened by a syringe needle 250 penetrating the sealers 181 and 182.

The outlet port Q6 of the second flow path P2 is disposed at the side facing the syringe 200. The outlet port Q6 is located at a distal end of the second flow path P2 in the direction opposite to the third direction D3.

The second flow path P2 includes a fourth section (not illustrated) and a fifth section (not illustrated). The fourth section and the fifth section are divided based on a second branch point Q4 between the second flow path P2 and the third flow path P3. The fourth section extends to connect the first branch point Q3 and the second branch point Q4. The fifth section extends to connect the second branch point Q4 and the outlet port Q6.

At least a portion of the syringe needle 250 of the syringe 200 may be inserted into the second flow path P2 of the drug mixing device 100. In this case, the liquid may flow along the flow path inside the syringe needle 250 disposed in the second flow path P2. The syringe needle 250 is inserted into the second flow path P2 in the third direction D3.

The second flow path P2 includes a portion extending in the third direction D3. The fifth section extends in a straight line. The second flow path P2 includes a portion extending in a straight line from a point where the first sealer 181 is disposed to the outlet port Q6. The second sealer 182, the second branch point Q4, the first sealer 181, and the outlet port Q6 are sequentially arranged on a straight line. Thus, the syringe needle 250 may be drawn inward through the outlet port Q6 to the point where the first sealer 181 is located. In the present embodiment, the entire second flow path P2 extends in a straight line.

The drug mixing device 100 has a third flow path P3 branched from the second flow path P2. The third flow path P3 extends to connect the second branch point Q4 located on the second flow path P2 and the third branch point Q5 located on the first flow path P1. The third flow path P3 is located in the drug mixing device 100.

The second branch point Q4 is located on the second flow path P2 between the point where the first sealer 181 is disposed and the point where the second sealer 182 is disposed. The third branch point Q5 is located between the first branch point Q3 and the one end Q1 on the first flow path P1. The second sealer 182 is disposed between the first branch point Q3 and the second branch point Q4 on the second flow path P2. The first sealer 181 is disposed between the second branch point Q4 and the outlet port Q6 on the second flow path P2.

The drug mixing device 100 includes a body 110. At least a portion of the flow path P may be formed in the body 110. The first flow path P1 may pass through the body 110. A portion of the first section, a portion of the second section and a portion of the third section may be formed in the body 110. The second flow path P2 and the third flow path P3 may be formed in the body 110.

The body 110 may be configured to be coupled to the first container 6 and the second container 7. The body 110 includes a first connection portion 111 to which the first container 6 can be coupled and a second connection portion 112 to which the second container 7 can be coupled. The body 110 includes a support portion 115 configured to support the first connection portion 111 and the second connection portion 112.

The body 110 may include a support part 110A, a first cover part 110B, and a second cover part 110C coupled to each other. The support part 110A and the first cover part 110B may be coupled to each other by a method such as laser bonding or ultrasonic bonding. The support part 110A and the second cover part 110C may be coupled to each other by a method such as laser bonding or ultrasonic bonding. The first cover part 110B may be coupled to a side surface of the support part 110A in the first direction D1. The second cover part 110C may be coupled to a side surface of the support part 110A in the second direction D2. The first flow path P1 may pass through the support part 110A, the first cover part 110B, and the second cover part 110C.

The support part 110A may include the first connection portion 111, the second connection portion 112, and the support portion 115. A first needle 150 may be fixed to the first cover part 110B. A second needle 160 may be fixed to the second cover part 110C. In the present embodiment, the first needle 150 and the second needle 160 are manufactured as separate members from the body 110 and fixed to the body 110. In another embodiment not illustrated, the first needle 150 and the second needle 160 are integrally molded with the entirety or a portion of the body 110 so that the first needle 150 and the second needle 160 can be fixed to the body 110.

The first cover part 110B may cover a partial section of the third flow path P3 and may be coupled to the support part 110A. A partial section of the third flow path P3 may be defined by the support part 110A and the first cover part 110B.

A backflow prevention part 130 may be disposed in the support part 110A. The second cover part 110C covers the backflow prevention part 130 and may be coupled to the support part 110A. The backflow prevention part 130 is disposed between the support part 110A and the second cover part 110C. A groove is formed on one side surface of the support part 110A, and the backflow prevention part 130 is inserted into the groove of the support part 110A. The groove of the support part 110A may be formed at one end of the third flow path P3.

A valve 120 may be disposed in the support part 110A. A portion of the valve 120 is exposed to an outside of the support part 110A, so that the user can manipulate the exposed portion of the valve 120 to open and close the first flow path P1.

In the present embodiment, the first connection portion 111 and the second connection portion 112 are configured to be hook-coupled with the first container 6 and the second container 7, respectively. However, in another embodiment not illustrated, the first connection portion and/or the second connection portion may be configured to be coupled to a corresponding container (the first container and/or the second container) by another method such as screwing.

In an embodiment, the first connection portion 111 includes a plurality of hooks 111a configured to be engaged with the first container 6. In the state in which the first container 6 is coupled to the drug mixing device 100, the plurality of hooks 111a may be arranged to be spaced apart from each other in a circumferential direction around the position of the first container 6. The plurality of hooks 111a may be arranged to be spaced apart from each other in the circumferential direction around the first needle 150. Each hook 111a includes a hook extension 111a1 extending in the first direction D1 from the support portion 115, and an engagement protrusion 111a2 protruding from a distal end in the first direction D1 of the hook extension 111a1 toward a center (in a direction facing the first needle).

In an embodiment, the second connection portion 112 includes a plurality of hooks 112a configured to be engaged with the second container 7. In the state in which the second container 7 is coupled to the drug mixing device 100, the plurality of hooks 112a may be arranged to be spaced apart from each other in a circumferential direction around the position of the second container 7. The plurality of hooks 112a may be arranged to be spaced apart from each other in the circumferential direction around the second needle 160. Each hook 112a includes a hook extension 112a1 extending in the second direction D2 from the support portion 115, and an engagement protrusion 112a2 protruding from a distal end in the second direction D2 of the hook extension 112a1 toward a center (in a direction facing the second needle).

The backflow prevention part 130 may be disposed in the support portion 115. The support portion 115 may constitute at least a portion of the support part 110A. The first cover part 110B and the second cover part 110C may be coupled to the support portion 115.

The support portion 115, the first connection portion 111, and the second connection portion 112 may be integrally formed by a method such as injection molding or the like. However, in the present embodiment, the first connection portion 111 and the second connection portion 112 are attached to the support portion 115. The body 110 may be formed by a method of fixing the first connection portion 111 and the second connection portion 112 to the support portion 115.

The body 110 forms at least a portion of the second flow path P2 configured to discharge a liquid into the syringe 200. In a state in which the sealers 181 and 182 are penetrated by the syringe needle 250, the liquid may flow through the second flow path P2.

The drug mixing device 100 includes the backflow prevention part (one-way valve) 130 disposed in the flow path P. The backflow prevention part 130 is disposed in the third flow path P3. The backflow prevention part 130 is configured to substantially prevent a flow of a liquid from the third branch point Q5 toward the second branch point Q4.

The backflow prevention part 130 functions as a check valve (one-way valve). The backflow prevention part 130 permits a flow (inflow) of a liquid moving from the second branch point Q4 to the third branch point Q5 but can block a flow (outflow) of a liquid from the third branch point Q5 to the second branch point Q4. Various types of backflow prevention parts capable of performing the function of the check valve may be configured.

In the present embodiment, the backflow prevention part 130 includes a protrusion (not illustrated) protruding in a direction of the inflow. The protrusion is made of a flexible material.

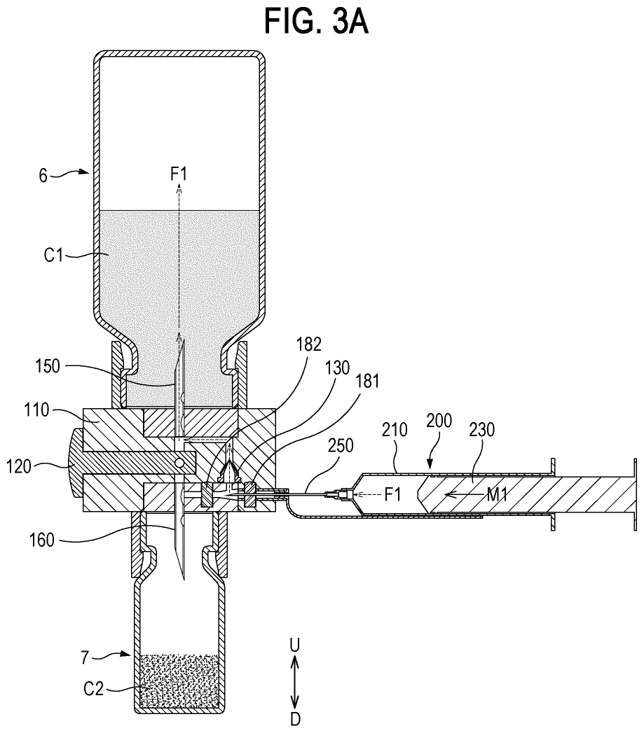

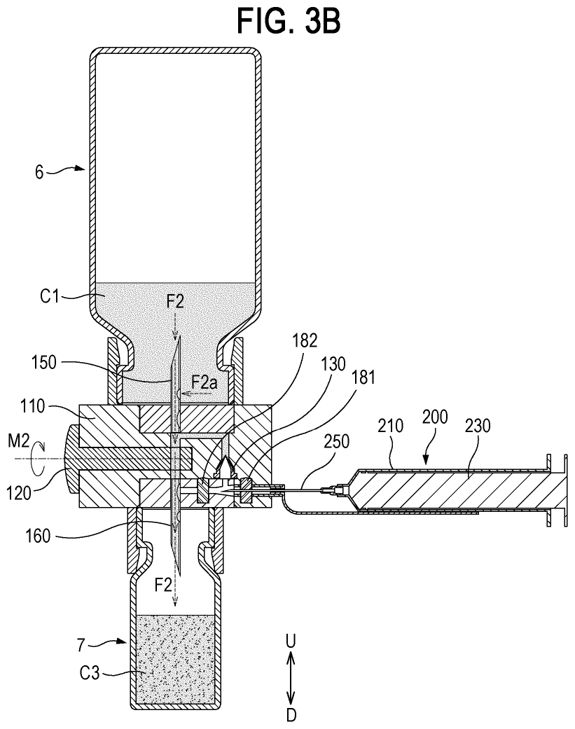

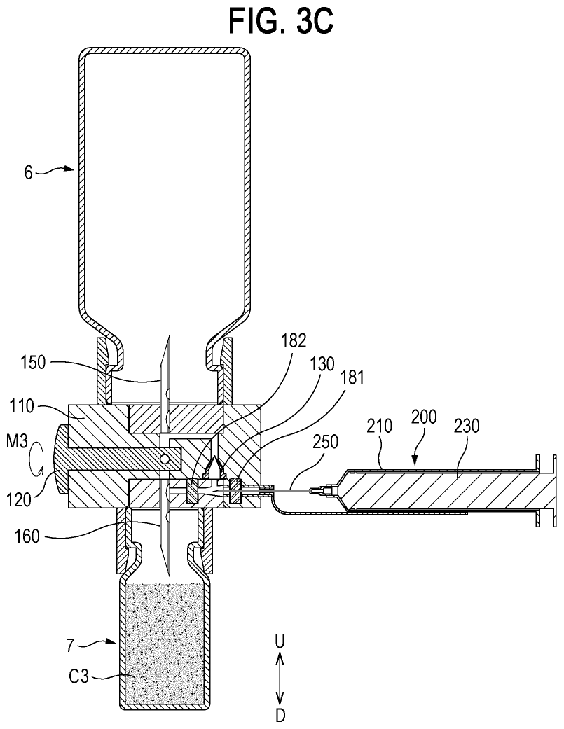

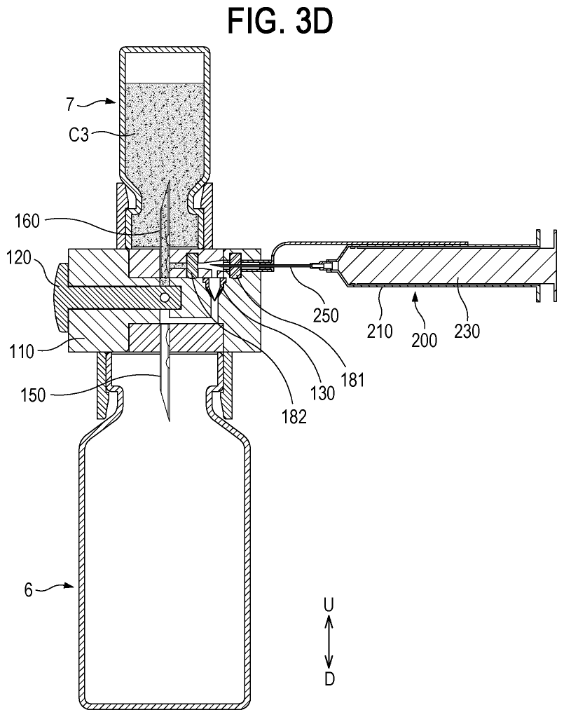

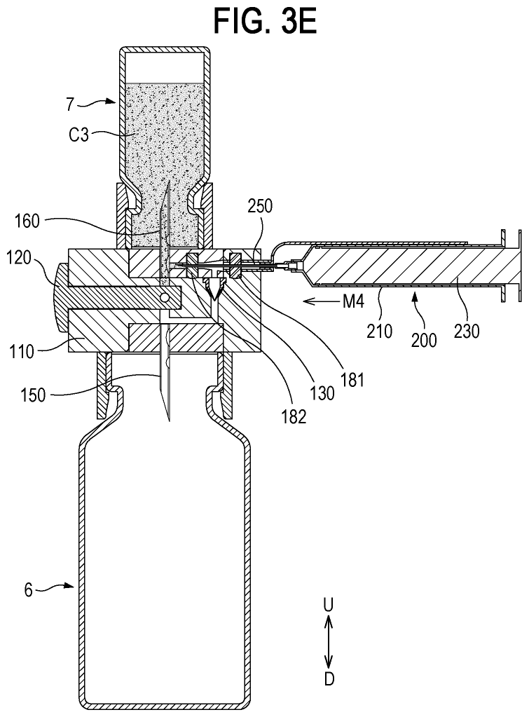

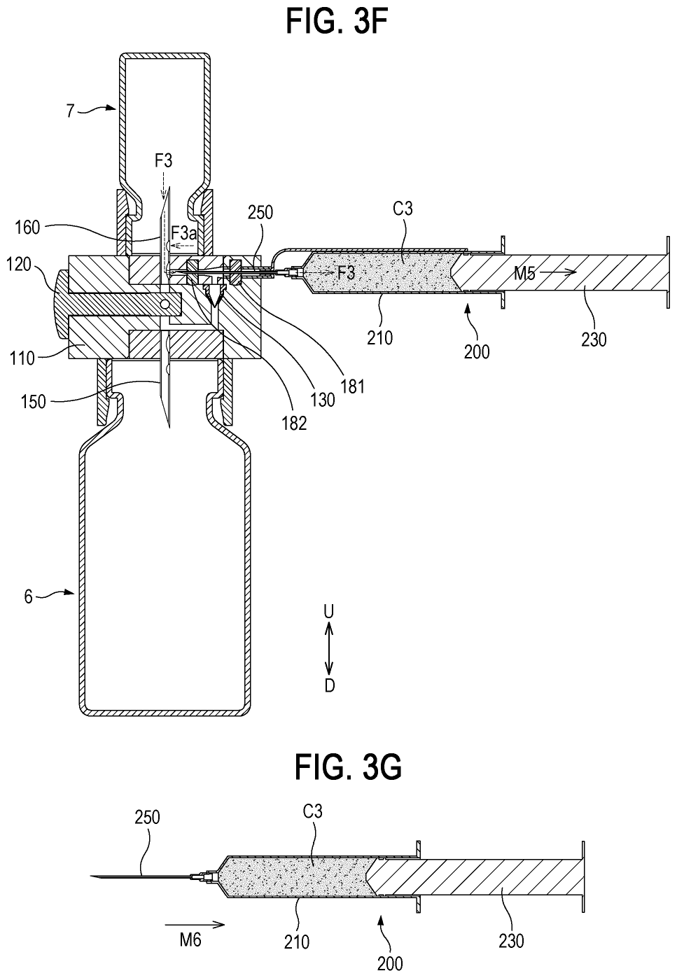

A hole (not illustrated) is formed at a protruding end of the protrusion. The hole of the protrusion is formed for a liquid to pass therethrough. Whether the hole of the protrusion is opened or closed varies depending on the flow direction of a liquid in the third flow path P3. When the liquid in the third flow path P3 flows in a direction F1 of the inflow, the hole of the protrusion is opened (see FIG. 3A). When there is no flow of a liquid in the third flow path P3 or when a liquid is about to flow in a direction of the outflow, the hole of the protrusion is closed (see FIG. 3B).

The backflow prevention part 130 includes a seating portion (not illustrated) seated on the body 110. The seating portion may be seated on the second cover part 110C. The seating portion supports the protrusion. A hole is formed at a center of the seating portion, and a liquid may move through the hole of the seating portion to the hole of the protrusion.

For example, the protrusion may be formed in a conical shape as a whole such that a vertex portion thereof protrudes. In this case, the hole of the protrusion is formed in the vertex portion.

As another example, the protrusion may include a first oblique surface extending to be inclined with respect to a protruding direction, a second oblique surface extending to be inclined in a direction opposite to the first oblique surface with respect to the protruding direction, and both side surfaces that cover both sides of the first oblique surface and the second oblique surface. In this case, the first oblique surface and the second oblique surface meet while forming an edge at a protruding end of the protrusion, and the hole of the protrusion extends lengthwise along the edge. When a liquid in the third flow path P3 flows in the direction of the inflow, a protruding end of the first oblique surface and a protruding end of the second oblique surface are bent in opposite directions to open the hole of the protrusion.

The drug mixing device 100 includes the first needle 150 protruding to be insertable into an interior of the first container 6. The first needle 150 may be formed in a form of an injection needle. The first needle 150 protrudes in the first direction D1. At an inlet of the first container 6, a film 6a made of a rubber material may be formed, and when the user couples the first container 6 to the drug mixing device 100, the first needle 150 can penetrate the film 6a.

The first needle 150 is fixed to the body 110. The first needle 150 may be fixed to the second cover part 110C. The first needle 150 may be fixedly inserted into the body 110. The first needle 150 defines therein at least a portion of the first flow path P1. The first needle 150 may define therein a portion of the first flow path P1 located inside the body 110. The first needle 150 may form a portion of the first flow path P1 extending from the body 110 in the first direction D1. The first needle 150 forms a side of the one end Q1 of the first flow path P1.

The first needle 150 forms a pointed end in the first direction D1 and forms a support end on the opposite side of the pointed end. The support end of the first needle 150 may be inserted into the body 110. A pointed end hole 150h1 is formed at the pointed end of the first needle 150, and a support end hole (not illustrated) is formed at the support end of the first needle 150. The first needle 150 forms a portion of the first flow path P1 connecting the pointed end hole 150h1 and the support end hole.

The drug mixing device 100 includes a second needle 160 protruding to be insertable into an interior of the second container 7. The second needle 160 may be formed in a form of an injection needle. The second needle 160 protrudes in the second direction D2. At an inlet of the second container 7, a film 7a made of a rubber material may be formed. When the user couples the second container 7 to the drug mixing device 100, the second needle 160 can penetrate the film 7a.

The second needle 160 is fixed to the body 110. The second needle 160 may be fixed to the support part 110A. The second needle 160 may be fixedly inserted into the body 110. The second needle 160 defines therein at least a portion of the first flow path P1. The second needle 160 may define therein a portion of the first flow path P1 located inside the body 110. The second needle 160 may define therein a portion of the first flow path P1 extending from the body 110 in the second direction D2. The second needle 160 forms a side of the other end Q2 of the first flow path P1.

The second needle 160 forms a pointed end in the second direction D2 and forms a support end on the opposite side of the pointed end. The support end of the second needle 160 may be inserted into the body 110. A pointed end hole 160h1 is formed at the pointed end of the second needle 160, and a support end hole (not illustrated) is formed at the support end of the second needle 160. The second needle 160 forms a portion of the first flow path P1 connecting the pointed end hole 160h1 and the support end hole.

In the present embodiment, the second needle 160 is inserted into the body 110 so that the support end of the second needle 160 is located at a position beyond the first branch point Q3 in the opposite direction to the second direction D2. The second needle 160 may form a flow path connection hole 160h4 opened in the extending direction of the second flow path P2 from the first branch point Q3. The first flow path P1 and the second flow path P2 may communicate with each other through the flow path connection hole 160h4.

In another embodiment not illustrated, the second needle 160 may be fixed to the body 110 so that the support end of the second needle 160 is located at a position spaced apart from the first branch point Q3 in the second direction D2. In this case, the flow path connection hole may not be formed in the second needle 160.

At least one of the first needle 150 and the second needle 160 may define therein a remaining amount inflow hole 150h3 or 160h3 on a side surface at a position spaced apart from the corresponding pointed end. The drug mixing device 100 is configured to enable a liquid to be introduced into the first flow path P1 through the remaining amount inflow hole 150h3 or 160h3 from the interior of the container 6 or 7 into which the at least one of the needles 150 and 160 is inserted. In the present embodiment, the remaining amount inflow holes 150h3 and 160h3 are formed in the first needle 150 and the second needle 160, respectively. Thus, when the liquids inside the containers 6 and 7 are introduced into the first flow path P1, a remaining amount of the liquids in the containers 6 and 7 can be reduced.

The drug mixing device 100 includes at least one sealer 181 or 182 disposed in the second flow path P2. The at least one sealer 181 or 182 includes the first sealer 181 configured to allow the needle 250 of the syringe 200 to pass therethrough. The at least one sealer 181 or 182 includes the second sealer 182 configured to allow the needle 250 of the syringe 200 to pass therethrough. The second sealer 182 is disposed in the second flow path P2 between the first branch point Q3 and the point where the first sealer 181 is disposed.

The sealers 181 and 182 may be made of a silicon material. In the initial state before the drug mixing in the drug mixing kit 1, the syringe needle 250 may be set to penetrate only the first sealer 181 between the first sealer 181 and the second sealer 182. The user may insert the syringe needle 250 deeper while using the drug mixing kit 1, so that the syringe needle 250 can penetrate both the first sealer 181 and the second sealer 182. The user may separate the syringe 200 from the drug mixing device 100 by withdrawing the syringe needle 250 from the first sealer 181 and the second sealer 182.

The drug mixing device 100 includes the valve 120 disposed in the first flow path P1. The valve 120 is disposed in the first flow path P1 to open and close a flow of a liquid. The valve 120 is disposed in the second section of the first flow path P1. The valve 120 is disposed at a position between the first branch point Q3 and the third branch point Q5. The valve 120 may open and close the flow of the liquid in the second section of the first flow path P1. For example, the valve 120 may be configured to control the opening and closing of the flow path P of the medicinal liquid by a rotation of the valve 120. The valve 120 may be configured to be rotatable in a rotation direction Rp about a rotation axis.

The drug mixing device 100 may include a supporter 190 configured to support the syringe 200. The supporter 190 is coupled to the body. The supporter 190 includes a body coupling portion 195 coupled to the body 110. The outlet port Q6 through which the syringe needle 250 passes may be formed at a center of the body coupling portion 195. A hole penetrating in the third direction D3 may be formed at the center of the body coupling portion 195. The hole of the body coupling portion 195 may face the first sealer 181 in the third direction D3. In another embodiment not illustrated, a thread may be formed around the outlet port Q6 of the body 110, and the thread and the supporter 190 may be fastened to each other.

The supporter 190 includes a support surface 191 that forms a surface which comes into contact with an outer surface of the syringe 200. For example, the support surface 191 may form an inner peripheral surface corresponding to an outer peripheral surface of the syringe. The support surface 191 may form an arc on a cross section perpendicular to the third direction D3. The support surface 191 extends in the third direction D3.

The supporter 190 includes a guide protrusion 192 protruding from the support surface 191 in an extension direction of the support surface 191. The guide protrusion 192 may guide coupling and/or separation of the syringe 200 and the drug mixing device 100.

The syringe 200 forms an internal space 200s that communicates with the second flow path P2. In the initial state before mixing a drug in the drug mixing kit 1, the syringe 200 is configured to fill the internal space 200s with sterile air. The syringe 200 is configured to suction a liquid from the second flow path P2 into the internal space 200s. The syringe 200 is configured to discharge air (fluid) from the internal space 200s to the second flow path P2. The internal space 200s is a space that can accommodate a fluid (a gas or a liquid). A volume of the internal space 200s is changed by a relative motion of a plunger 230 with respect to a syringe housing 210, whereby the fluid (e.g., the sterile air) is discharged from the internal space 200s or suctioned into the internal space 200s.

The syringe 200 includes a syringe flow path (not illustrated) connecting the second flow path P2 and the internal space 200s. The syringe needle 250 may form at least a portion of the syringe flow path. In a state in which the syringe 200 and the drug mixing device 100 are coupled to each other, a portion of the syringe flow path may be disposed in the second flow path P2.

The syringe 200 includes the syringe housing 210 defining an exterior. The space 200s is formed in the syringe housing 210. The syringe housing 210 has the internal space 200s. A syringe hole (not illustrated) communicating with the internal space 200s is formed in the syringe housing 210. The syringe hole forms a portion of the syringe flow path. The syringe housing 210 is coupled to the syringe needle 250.

The syringe 200 includes the plunger 230 configured to be movable inside the syringe housing 210. The plunger 230 is configured to change the volume of the internal space 200s by being inserted into the syringe housing 210 and being moved. The internal space 200s is defined by a pressing surface (not illustrated) of the plunger 230 and an inner surface of the syringe housing 210. The plunger 230 is configured to be movable in a discharge motion direction Dp1 in which the pressing surface faces the internal space 200s and an inflow motion direction Dp2 opposite to the discharge motion direction Dp1.

The plunger 230 may include a gasket (not illustrated) in contact with the inner surface of the syringe housing 210. The plunger 230 may include a plunger body portion (not illustrated) to which the gasket is fixed. The plunger body portion may extend to an outside of the opening of one side of the syringe housing 210. A manipulation portion (not illustrated) configured to make contact with and engage with a user's hand may be formed at a distal end of the plunger body portion in the inflow movement direction Dp2.

The syringe 200 includes the syringe needle 250 protruding to an outside of the syringe housing 210. The syringe needle 250 is configured to pass through the first sealer 181 and the second sealer 182. The syringe needle 250 connects the second flow path P2 and the internal space 200s to each other. The syringe needle 250 forms a flow path for guiding a flow of a liquid between the second flow path P2 and the internal space 200s. The syringe needle 250 may protrude in the third direction D3 to form a pointed end. The syringe needle 250 may be configured to be insertable into a patient's skin. The syringe needle 250 may be fixed to the syringe housing 210.

A method for manufacturing the drug mixing device 100 (manufacturing method) may include a step of manufacturing the first connection portion 111 and the second connection portion 112 of the body 110. The first connection portion 111 and the second connection portion 112 may be manufactured according to a design content that meets product specifications. The first connection portion 111 and the second connection portion 112 may be injection-molded.

The manufacturing method may include a step of fixing the first connection portion 111 and the second connection portion 112 to the support portion 115 (fixing step). The first connection portion 111 and the second connection portion 112 may be fixed to the support portion 115 by a method such as laser bonding or ultrasonic bonding. By including the fixing step, it is possible to efficiently manufacture various types of drug mixing devices 100 by separately manufacturing the first connection portion 111 and the second connection portion 112 suitable for a shape or size of the first container 6 and the second container 7 to be coupled to the drug mixing device 100 and commonly producing the remaining portions of the body 110 including the support portion 115.

FIGS. 3A to 3G are vertical cross-sectional views illustrating the drug mixing device 100, the syringe 200, the first container 6, and/or the second container 7 taken along the line S1-S1′ in FIG. 1 and sequentially showing an example of using the drug mixing kit 1 of FIG. 1. In FIGS. 3A to 3F, it can be understood that the supporter 190 and the syringe 200 are depicted in an exaggeratedly small size. Referring to FIGS. 3A to 3G, one usage example will be described as follows.

Referring to FIG. 3A, the user prepares the drug mixing kit 1. As an example, the user may purchase the drug mixing kit 1 including the drug mixing device 100 and the syringe 200 coupled to each other. Thus, the user may prepare the drug mixing kit 1 without a separate operation of coupling the drug mixing device 100 and the syringe 200. As another example, the user may prepare the drug mixing kit 1 by purchasing each of the drug mixing device 100 and the syringe 200 and coupling the syringe 200 to the drug mixing device 100. In the latter case, the user may firstly couple the first container 6 and the second container 7 to the drug mixing device 100, and then couple the syringe 200 to the drug mixing device 100.

The user couples the first container 6 and the second container 7, each of which contains a medically necessary content, to the drug mixing device 100. The user couples the first container 6 containing a first content C1 in a liquid form and the second container 7 containing a second content C2 in a liquid or powder form to the drug mixing kit 1. In this regard, both ends of the first flow path P1 communicate with the interiors of the first container 6 and the second container 7, respectively.

Referring to FIG. 3A, in the initial state, sterilized air is accommodated in the internal space 200s of the syringe 200. In the initial state, the valve 120 closes the second section of the first flow path P1. The user holds the drug mixing kit 1 so that the first container 6 is disposed in an upward direction U and the second container 7 is disposed in a downward direction D. In this state, when the user moves the plunger 230 with respect to the syringe housing 210 in the discharge motion direction M1 to decrease the volume of the internal space 200s, the air in the internal space 200s flows into the first container 6 through a portion of the second flow path P2, the third flow path P3, and the first section of the first flow path P1 (see arrow F1). At this time, a pressure inside the first container 6 is higher than a pressure inside the second container 7. At this time, even if the pressure inside the first container 6 is relatively high, the first content C1 does not flow into the internal space 200s of the syringe 200 due to the backflow prevention part 130.

Referring to FIG. 3B, when the user rotates the valve 120 (see M2) to open the first flow path P1, the first content C1 inside the first container 6 flows into the second container 7 through the first flow path P1 (see arrow F2). Since the pressure inside the first container 6 is relatively high in the process of FIG. 3A, the user can introduce the first content C1 into the second container 7 by merely opening the valve 120. At this time, the first content C1 inside the first container 6 may be introduced into the first flow path P1 through the remaining amount inflow hole 150h3 (see arrow F2a). When the first content C1 is introduced into the second container 7, the user shakes the drug mixing kit 1 lightly to thereby produce a mixture C3 of the first content C1 and the second content C2 in the second container 7.

Referring to FIG. 3C, the user rotates the valve 120 (see M3) so that the valve 120 closes the first flow path P1.

Referring to FIG. 3D, the user holds the drug mixing kit 1 so that the second container 7 is disposed in the upward direction U and the first container 6 is disposed in the downward direction D.

Referring to FIG. 3E, the user moves the syringe 200 in the third direction D3 (see M4) so that the syringe needle 250 penetrates the second sealer 182.

Referring to FIG. 3F, when the user increases the volume of the internal space 200s by moving the plunger 230 with respect to the syringe housing 210 in an inflow motion direction M5, the mixture C3 in the second container 7 flows into the internal space 200s of the syringe 200 through the third section of the first flow path P1 and the second flow path P2 (see arrow F3). At this time, the mixture C3 in the second container 7 may be introduced into the first flow path P1 through the remaining amount inflow hole 160h3 (see arrow F3a).

Referring to FIG. 3G, the user may separate the syringe 200 from the drug mixing device 100 (see M6). The user may inject the drug mixture C3 into a patient by putting the syringe needle 250 of the syringe 200 into the patient's skin.

The technical idea of the present disclosure has been described heretofore with reference to some embodiments and examples illustrated in the accompanying drawings. However, it is to be understood that various substitutions, modifications and alterations may be made without departing from the technical idea and scope of the present disclosure that can be understood by those of ordinary skill in the technical field to which the present disclosure pertains. Further, it is to be understood that such substitutions, modifications and alterations fall within the appended claims.

What is claimed is:

1. A drug mixing device for mixing a first content in a liquid form in a first container and a second content in a liquid or powder form in a second container,
wherein a first flow path extending from one end configured to allow a liquid inside the first container to flow into the first flow path through the one end to the other end configured to allow a liquid inside the second container to flow into the first flow path through the other end, a second flow path branching from a first branch point located on the first flow path and extending to an outlet port, and a third flow path extending to connect a second branch point located on the second flow path and a third branch point located on the first flow path are formed in the drug mixing device,
the drug mixing device comprising:
a body including a first connection portion configured to be coupled with the first container and a second connection portion configured to be coupled with the second container;
a first sealer disposed in the second flow path and configured to be penetrated by a needle of a syringe; and
a second sealer disposed in the second flow path at a position between the first branch point and a point where the first sealer is disposed, and configured to be penetrated by the needle of the syringe,
wherein the second branch point is located on the second flow path between the point where the first sealer is disposed and a point where the second sealer is disposed.

2. The drug mixing device of claim 1, wherein the third branch point is located on the first flow path between the first branch point and the one end of the first flow path.

3. The drug mixing device of claim 1, wherein the second sealer, the second branch point, the first sealer, and the outlet port are sequentially arranged on a straight line.

4. The drug mixing device of claim 1, further comprising:
a backflow prevention part disposed in the third flow path and configured to prevent a liquid from flowing from the third branch point to the second branch point.

5. The drug mixing device of claim 1, further comprising:
a valve disposed in the first flow path and configured to open and close a flow of a fluid.

6. The drug mixing device of claim 5, wherein the valve is disposed at a position between the first branch point and the third branch point.

7. The drug mixing device of claim 1, wherein the first connection portion includes a plurality of hooks configured to be engaged with the first container,
the second connection portion includes a plurality of hooks configured to be engaged with the second container, and
the body includes a support portion supporting the first connection portion and the second connection portion.

8. The drug mixing device of claim 7, further comprising:
a first needle forming a side of the one end of the first flow path and protruding to be insertable into an interior of the first container; and
a second needle forming a side of the other end of the first flow path and protruding to be insertable into an interior of the second container,
wherein the plurality of hooks of the first connection portion are arranged to be spaced apart from each other in a circumferential direction around the first needle, and
the plurality of hooks of the second connection portion are arranged to be spaced apart from each other in a circumferential direction around the second needle.

9. The drug mixing device of claim 1, further comprising:
a first needle forming a side of the one end of the first flow path and protruding to be insertable into an interior of the first container; and
a second needle forming a side of the other end of the first flow path and protruding to be insertable into an interior of the second container.

10. The drug mixing device of claim 9, wherein the first needle and the second needle are fixed to the body.

11. The drug mixing device of claim 9, wherein at least one needle of the first needle and the second needle defines therein a remaining amount inflow hole in a side surface at a position spaced apart from a pointed end thereof, and
the drug mixing device is configured to enable a liquid to flow into the first flow path from an interior of a container, into which the at least one needle is inserted, through the remaining amount inflow hole.

12. The drug mixing device of claim 1, further comprising:
a supporter coupled to the body and configured to support the syringe.

13. A method of manufacturing the drug mixing device of claim 7, the method comprising:
fixing the first connection portion and the second connection portion to the support portion.

14. A drug mixing kit for mixing a first content in a liquid form in a first container and a second content in a liquid or powder form in a second container, the drug mixing kit comprising:
a drug mixing device in which a first flow path extending from one end configured to allow a liquid inside the first container to flow into the first flow path through the one end to the other end configured to allow a liquid inside the second container to flow into the first flow path through the other end, a second flow path branching from a first branch point located on the first flow path and extending to an outlet port, and a third flow path extending to connect a second branch point located on the second flow path and a third branch point located on the first flow path are formed; and
a syringe including:
a syringe housing having an internal space,
a plunger configured to change a volume of the internal space by being inserted into the syringe housing and moving, and
a syringe needle connecting the second flow path and the internal space to each other,
wherein the drug mixing device includes:
a body including a first connection portion configured to be coupled with the first container and a second connection portion configured to be coupled with the second container,
a first sealer disposed in the second flow path and configured to be penetrated by the syringe needle, and
a second sealer disposed in the second flow path at a position between the first branch point and a point where the first sealer is disposed, and configured to be penetrated by the syringe needle, and
wherein the second branch point is located on the second flow path between the point where the first sealer is disposed and a point where the second sealer is disposed.

15. The drug mixing kit of claim 14, wherein the drug mixing device and the syringe are detachably coupled to each other.

16. The drug mixing kit of claim 14, wherein the third branch point is located on the first flow path between the first branch point and the one end of the first flow path.

17. The drug mixing kit of claim 14, wherein the first sealer, the second branch point, the second sealer, and the outlet port are sequentially arranged on a straight line.

18. The drug mixing kit of claim 14, further comprising:
a backflow prevention part disposed in the third flow path and configured to prevent a liquid from flowing from the third branch point to the second branch point.

19. The drug mixing kit of claim 14, further comprising:
a valve disposed in the first flow path and configured to open and close a flow of a fluid in the first flow path.

20. The drug mixing kit of claim 19, wherein the valve is disposed at a position between the first branch point and the third branch point.
